(19) United States
(12) Patent Application Publication
(10) Pub. No.: US 2008/0077967 A1
(43) Pub. Date: Mar. 27, 2008

(54) VIDEO RECEIVING DEVICE, VIDEO DATA RECEIVING SYSTEM AND AUTHENTICATION CONTROL METHOD THEREOF

(75) Inventors: Masahiko NAGOSHI, Osaka (JP); Osamu TANAKA, Osaka (JP); Hiroyuki WATANABE, Osaka (JP); Toyoshi YAMADA, Osaka (JP); Nobuhiko ARASHIN, Osaka (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/861,451

(22) Filed: Sep. 26, 2007

(30) Foreign Application Priority Data
Sep. 27, 2006 (JP) JP 2006-263461

(51) Int. Cl. H04N 7/16

(52) U.S. Cl. 725/151

(57) ABSTRACT

Television viewing can be performed at a video receiving device which receives an authentication, even if the power of a video receiving device which performs the authentication is turned off by a video data receiving system in which video receiving devices are connected to one another via a network for authentication, each of the video receiving devices having:
an authentication unit which has an authentication function; and
an authentication privilege management unit which manages an authentication privilege for enabling the authentication function,
wherein the authentication unit of the video receiving device having an authentication privilege can permit other video receiving devices to receive the external video data, and
when the power of the video receiving device having the authentication privilege is turned off, the power of the video receiving device is turned off after the authentication privilege management unit of the video receiving device has delegated the authentication privilege to other video receiving devices which have been connected to the network and with which links have been established.

### BACKGROUND OF THE INVENTION

1. Field of the Invention

The present invention relates to a video receiving device, a video data receiving system, an authentication control method thereof and the like. For example, the present invention relates to multiple video receiving devices for which subscription to a company such as a CATV station has been performed, a video data receiving system, an authentication control method thereof and the like.

2. Related Art of the Invention

When a user subscribes to a cable television company and uses a home receiving device (STB) by rental and the like for viewing a cable television and the like, cost is required for each one home receiving device. Therefore, a significant burden is imposed on the user when the user subscribes for multiple rental home receiving devices in one home, which is a challenge for the cable television company in increasing the number of subscribers.

Consequently, as one of services of the cable television company, subscription fee for the second or more home receiving devices (hereinafter referred to as “secondary subscriber home receiving devices”) is often set to be inexpensive in comparison to that for the first home receiving device (hereinafter referred to as “primary subscriber home receiving device”), if one home subscribes for the multiple home receiving devices.

FIG. 8(A) shows a configuration diagram showing a connection with a CATV station in the case where one home has subscribed for two home receiving devices.

A subscriber home 87 has subscribed for two rental home receiving devices, that is, a primary subscriber home receiving device 81 and a secondary subscriber home receiving device 82. Broadcast program data delivered from a CATV station 84 is distributed by a distributor 85, and the primary subscriber home receiving device 81 and the secondary subscriber home receiving device 82 are connected to television outlets 83 and 86 connected to the distributor 85, respectively.

Broadcast programs from the CATV station 84 can be simultaneously viewed at televisions and the like connected to the primary subscriber home receiving device 81 and the secondary subscriber home receiving device 82, by connecting video output devices such as the televisions to the primary subscriber home receiving device 81 and the secondary subscriber home receiving device 82, respectively.

Here, since the subscriber home 87 has subscribed for the two home receiving devices, the subscriber home 87 can use the second device, that is, the secondary subscriber home receiving device 82, at less expensive subscription fee than that for the first device, that is, the primary subscriber home receiving device 81.

However, it is possible to take advantage of the fact that the secondary subscriber home receiving device is also a similar device as the first device, that is, the primary subscriber home receiving device, bring the secondary subscriber home receiving device into another home which is not a subscriber (hereinafter called “nonsubscriber home”), in an area where the delivery from the same company can be received, connect that secondary subscriber home receiving device to the television outlet in that home, and perform television viewing at that nonsubscriber home.

FIG. 8(B) shows a configuration diagram showing a connection with the CATV station in such an unauthorized form of usage. It should be noted that the same reference numerals are used for the same component parts as FIG. 8(A).

A nonsubscriber home 88 is a home which has not subscribed to the CATV station 84. However, the nonsubscriber home 88 is located in the same area where the subscriber home 87 which can receive the broadcast program data delivered from the CATV station 84 is located, and can receive the broadcast program data from the CATV station 84 via a television outlet 89.

However, since the nonsubscriber home 88 has no home receiving device, the nonsubscriber home 88 usually connects the video output device such as the television directly to the television outlet 89 and views only programs which can be viewed without the subscription. Although the broadcast program data of programs requiring the subscription is also outputted from the television outlet 89, that broadcast program data has been scrambled, so that it cannot be viewed without using the home receiving device.

However, as shown in FIG. 8(B), when the secondary subscriber home receiving device 82 used at the subscriber home 87 is brought into the nonsubscriber home 88 and connected to the television outlet 89, programs which cannot be viewed without the subscription can also be viewed at the nonsubscriber home 88. Moreover, in this case, at the subscriber home 87, even if the secondary subscriber home receiving device 82 is not connected, the primary subscriber home receiving device 81 can be used to view the programs which cannot be viewed without the subscription.

In other words, this case means that the nonsubscriber home 88 can perform the television viewing with respect to the program requiring the subscription, at unreasonably cheaper subscription fee which has been set for the second or more devices, that is, the secondary subscriber home receiving devices.

As a method of eliminating such an unauthorized use, an authentication technique which limits the television viewing by performing authentication when a function of television delivery between the primary subscriber home receiving device and the secondary subscriber home receiving device is used has been provided (for example, see Japanese Patent Laid-Open No. 10-322676).

FIG. 9 shows a configuration diagram showing a connection between two home receiving devices using the authentication technique disclosed in Japanese Patent Laid-Open No. 10-322676, and the CATV station. It should be noted that the same reference numerals are used for the same component parts as FIG. 8.

Only a primary subscriber home receiving device 90 is connected to the television outlet 83, and a secondary subscriber home receiving device 91 is not connected to the television outlet and connected to the primary subscriber home receiving device 90 via a communication cable 92.

The broadcast program data delivered from the CATV station 84 is transferred from the primary subscriber home receiving device 90 to the secondary subscriber home receiving device 91 via the communication cable 92, by using a broadcast program communication channel 93 at a high frequency band.

Moreover, terminal-to-terminal communication between the primary subscriber home receiving device 90 and the secondary subscriber home receiving device 91 is performed via the communication cable 92, by using a terminal-to-terminal communication channel 94 assigned at a frequency band lower than the broadcast program communication channel 93.

The primary subscriber home receiving device 90 transfers the broadcast program data from the CATV station 84 to the secondary subscriber home receiving device 91, and also creates a viewing key as authentication data and sends it to the secondary subscriber home receiving device 91 by using the terminal-to-terminal communication channel 94.

The viewing key includes a master terminal ID, a slave terminal permission ID and a program ID. When the secondary subscriber home receiving device 91 receives the viewing key, the secondary subscriber home receiving device 91 compares its own ID and the slave terminal permission ID included in the viewing key. If they have a predetermined relationship, the secondary subscriber home receiving device 91 determines that the broadcast program data is viewable broadcast program data, and descrambles the broadcast program data from the CATV station 84 to make it viewable.

In this way, since the secondary subscriber home receiving device 91 cannot view the broadcast program data delivered from the CATV station 84 without being authenticated by the corresponding primary subscriber home receiving device 90, the programs requiring the subscription cannot be viewed at the nonsubscriber home 88 even if the secondary subscriber home receiving device 91 is connected to the television outlet 89 at the nonsubscriber home 88, as shown in FIG. 8(B).

As described above, the unauthorized use in which the television viewing is performed with respect to the program requiring the subscription, at unreasonably cheaper subscription fee, has been prevented.

However, in the configuration using the above described conventional authentication technique, the primary subscriber home receiving device is always required when the authentication is performed between the primary subscriber home receiving device and the secondary subscriber home receiving device, which causes a problem in which power of the primary subscriber home receiving device must be turned on even if only a legitimate secondary subscriber home receiving device is used.

This problem will be described below.

The authentication between the primary subscriber home receiving device and the secondary subscriber home receiving device is performed when a link with the primary subscriber home receiving device has been established at the time of turning on power of the secondary subscriber home receiving device and the like, or when a channel viewed at the secondary subscriber home receiving device has been changed, or is periodically performed at predetermined intervals. If only the secondary subscriber home receiving device is used, the power of the primary subscriber home receiving device must be turned on only when the authentication is performed. However, since the authentication is frequently performed as described above, the viewing at the secondary subscriber home receiving device has not actually been possible unless the power of the primary subscriber home receiving device is continuously turned on.

### SUMMARY OF THE INVENTION

The present invention has been made in view of the above described conventional problem, and it is an object of the present invention to provide a video receiving device, a video data receiving system, an authentication control method thereof and the like, in which television viewing can be performed at a video receiving device which receives an authentication, even if power of a video receiving device which performs the authentication is turned off.

To solve the above problems, the first aspect of the present invention is a video data receiving system in which multiple video receiving devices are connected to one another via a network for authentication, each of said multiple video receiving devices comprising:

a power control unit which senses an instruction of turning off power and an instruction of turning on the power;

a video data receiving unit which receives at least external video data;

a network interface unit which connects to said network for the authentication;

an authentication unit which has an authentication function; and

an authentication privilege management unit which manages an authentication privilege for enabling said authentication function of said authentication unit,

wherein said authentication unit can permit other video receiving devices to receive said external video data, by said authentication function, and

when the power of a predetermined one of the video receiving devices having said authentication privilege is turned off, the power of said predetermined video receiving device is turned off after said authentication privilege management unit of said predetermined one of the video receiving devices has delegated said authentication privilege to any of other video receiving devices which have been connected to said network and with which links have been established.

The second aspect of the present invention is the video data receiving system according to the first aspect of the present invention, wherein said multiple video receiving devices are one master video receiving device and one or a plurality of slave video receiving devices which are other than said master video receiving device, and

if the power is turned on in a state where said master video receiving device does not have said authentication privilege, when a link with said slave video receiving device having said authentication privilege has been established in said network, said authentication privilege is delegated from said slave video receiving device to said master video receiving device.

The third aspect of the present invention is the video data receiving system according to the second aspect of the present invention, wherein said master video receiving device is provided with a recording unit which records said video data received by said video data receiving unit.

The fourth aspect of the present invention is the video data receiving system according to the first aspect of the present invention, wherein the video receiving device having said authentication privilege retains said authentication privilege until the power of that video receiving device is turned off.

The fifth aspect of the present invention is the video data receiving system according to the first aspect of the present invention, wherein when the power of the video receiving device having said authentication privilege is turned off, said authentication privilege management unit of that video receiving device has previously stored which video receiving device is the video receiving device to which said authentication privilege has been delegated among other video receiving devices.

The sixth aspect of the present invention is the video data receiving system according to the fifth aspect of the present invention, wherein when the power of the video receiving device having said authentication privilege is turned on again, said authentication privilege management unit of that video receiving device notifies information related to the video receiving device to which said authentication privilege has been delegated.

The seventh aspect of the present invention is the video data receiving system according to the first aspect of the present invention, wherein when the power of the video receiving device having said authentication privilege is turned off, a warning is notified if there is no other video receiving device with which the link has been established in said network.

The eighth aspect of the present invention is the video data receiving system according to the first aspect of the invention, wherein said power control unit has a function capable of turning off the power for operating other functions while the power for operating at least said network interface unit, said authentication unit and said authentication privilege management unit is turned on, and

when the power of the video receiving device having said authentication privilege is turned off, if there is no other video receiving device with which the link has been established in said network, the power for operating other functions is turned off while the power for operating said network interface unit, said authentication unit and said authentication privilege management unit is turned on.

The ninth aspect of the present invention is the video data receiving system according to the first aspect of the present invention, wherein said other video receiving device to which said authentication privilege management unit of said predetermined one of the video receiving devices delegates said authentication privilege is determined based on statistical information related to frequency of usage of each of said multiple video receiving devices.

The tenth aspect of the present invention is the video data receiving system according to the first aspect of the present invention, wherein said external video data is broadcast program data from a cable television station, and

each of said video receiving devices is an STB for a cable television.

The eleventh aspect of the present invention is the video data receiving system according to the tenth aspect of the present invention, wherein said network is a cable network which uses a cable used for transmitting said broadcast program data.

The twelfth aspect of the present invention is a video receiving device comprising:

a power control unit which senses an instruction of turning off power and an instruction of turning on the power;

a video data receiving unit which receives at least external video data;

a network interface unit which connects to a network for authentication;

an authentication unit which has an authentication function; and

an authentication privilege management unit which manages an authentication privilege for enabling said authentication function of said authentication unit,

wherein said authentication unit permits other video receiving devices to receive said external video data, by said authentication function, and

when the power is turned off in a state of having said authentication privilege, the power is turned off after said authentication privilege management unit has delegated said authentication privilege to any of other video receiving devices which have been connected to said network and with which links have been established.

The thirteenth aspect of the present invention is an authentication control method for a video data receiving system in which multiple video receiving devices are connected to one another via a network for authentication, each of said multiple video receiving devices having a power control unit which senses an instruction of turning off power and an instruction of turning on the power; a video data receiving unit which receives at least external video data; a network interface unit which connects to said network for the authentication; an authentication unit which has an authentication function; and an authentication privilege management unit which manages an authentication privilege for enabling said authentication function of said authentication unit, said method comprising:

an authentication step in which said authentication unit permits other video receiving devices to receive said external video data, by said authentication function, and

an authentication privilege delegation step in which when the power of a predetermined one of the video receiving devices having said authentication privilege is turned off, said authentication privilege management unit of said predetermined one of the video receiving devices delegates said authentication privilege to any of other video receiving devices which have been connected to said network and with which links have been established, before the power is turned off.

The fourteenth aspect of the present invention is a recording medium which can be used in a computer, having recorded a program which causes a computer to execute said authentication step in which said authentication unit permits said other video receiving devices to receive said external video data, and said authentication privilege delegation step in which said authentication privilege management unit of said predetermined one of the video receiving devices delegates said authentication privilege to any of other video receiving devices which have been connected to said network and with which the links have been established, of an authentication control method for a video data receiving system according to the thirteenth aspect of the present invention.

According to the present invention, it is possible to provide the video receiving device, the video data receiving system, the authentication control method thereof and the like, in which the television viewing can be performed at the video receiving device which receives the authentication, even if the power of the video receiving device which performs the authentication is turned off.

### BRIEF DESCRIPTION OF THE DRAWINGS

FIG. 1 is a block diagram showing a configuration of a home receiving device of first and second embodiments of the present invention;

FIG. 2 is a connection configuration diagram of a CATV system in a home subscribing for multiple home receiving devices of the first and second embodiments of the present invention;

FIG. 3 is a diagram showing a flowchart of operations of a primary subscriber home receiving device in the case where main power of the primary subscriber home receiving device has been turned off and subsequently turned on again, in a subscriber home having the home receiving device of the first embodiment of the present invention;

FIG. 4 is a diagram showing a flowchart of operations of a secondary subscriber home receiving device to which a representation right is delegated in the case where the main power of the primary subscriber home receiving device has been turned off, in the subscriber home having the home receiving device of the first embodiment of the present invention;

FIG. 5(A) is a configuration diagram of a connection example in the case where unauthorized television viewing is attempted in the CATV system provided with the home receiving device of the first embodiment of the present invention;

FIG. 5(B) is a configuration diagram of a connection example in the case where the unauthorized television viewing is attempted in the CATV system provided with the home receiving device of the first embodiment of the present invention;

FIG. 6 is a diagram showing a flowchart of operations of the respective secondary subscriber home receiving devices in the case where main power of the secondary subscriber home receiving device retaining the representation right has been turned off, in a subscriber home having the home receiving device of the second embodiment of the present invention;

FIG. 7 is a block diagram showing a configuration example of a home receiving device as the primary subscriber home receiving device of the present invention;

FIG. 8(A) is a configuration diagram showing a conventional connection with a CATV station in the case where one home has subscribed two home receiving devices;

FIG. 8(B) is a configuration diagram showing a connection between the home receiving device and the CATV station in an unauthorized form of usage in a conventional CATV system; and

FIG. 9 is a configuration diagram showing a connection between two home receiving devices using a conventional authentication technique and the CATV station.

### DESCRIPTION OF SYMBOLS

10, 100 Home receiving device
11 Primary subscriber home receiving device
12 Secondary subscriber home receiving device
13 Secondary subscriber home receiving device
14 CATV station
15 Distributor
16 Home LAN
17 Subscriber home
18 Nonsubscriber home
19 Distributor
20 Video output device
21 Broadcast receiving unit
22 Authentication unit
23 Network I/F unit
24 Authentication privilege management unit
25 Power SW
26 Power control unit
27 Broadcast recording unit

### PREFERRED EMBODIMENTS OF THE INVENTION

Embodiments of the present invention will be described below with reference to the drawings.

### First Embodiment

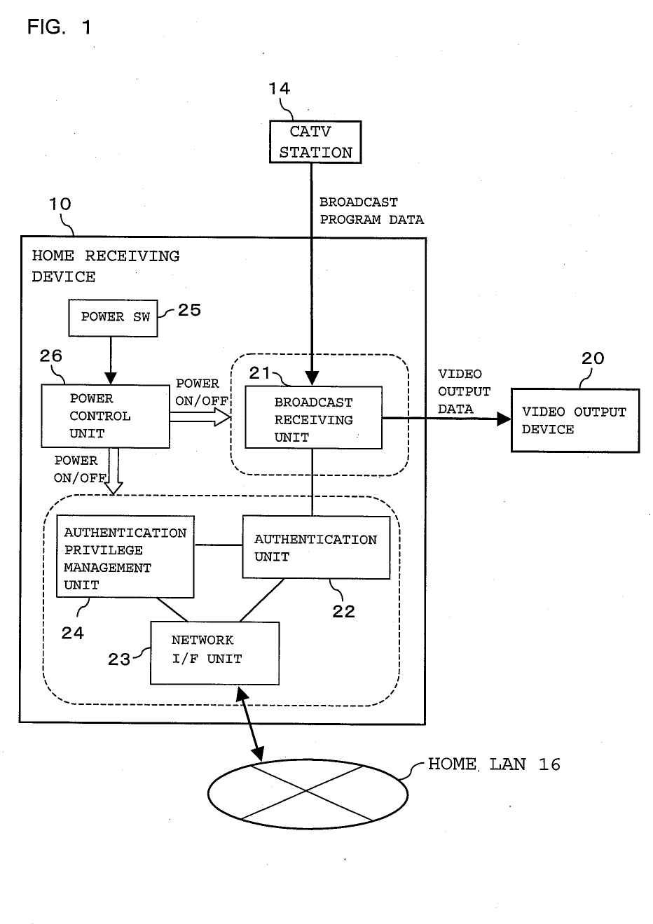

FIG. 1 shows a block diagram showing a configuration of a home receiving device (Set Top Box:STB) of a first embodiment of the present invention. Both of a primary subscriber home receiving device for which subscription has been performed as a first device and secondary subscriber home receiving devices for which the subscription has been performed as second and more devices have a similar configuration as shown in FIG. 1.

A home receiving device 10 of this first embodiment is provided with a broadcast receiving unit 21 which receives broadcast program data delivered from a CATV station 14 and outputs video output data for a video output device 20 such as a television.

Moreover, the home receiving device 10 is provided with an authentication unit 22 which has an authentication function for permitting another home receiving device 10 connected via a home LAN 16 to receive the broadcast program data from the CATV station 14, and an authentication receiving function for receiving the permission to receive the broadcast program data from the CATV station 14, from another home receiving device 10. Moreover, the home receiving device 10 is provided with an authentication privilege management unit 24 which manages whether or not to enable the authentication function included in the authentication unit 22.

Moreover, the home receiving device 10 uses a network I/F unit 23 to perform terminal-to-terminal communication with another home receiving device 10 connected via the home LAN 16.

Moreover, the home receiving device 10 is provided with a power control unit 26 which senses on/off of a power SW 25 and controls a power state of the home receiving device 10, depending on on/off of the power SW 25. The power control unit 26 has a function for enabling power supplied to other parts such as the broadcast receiving unit 21 to be turned off, while turning on power supplied to at least component parts related to the authentication with respect to another home receiving device 10, that is, parts of the authentication unit 22, the authentication privilege management unit 24 and the network I/F unit 23. Of course, the power control unit 26 can control to turn off power of all units within the home receiving device 10.

The broadcast program data received from the CATV station 14 has been scrambled. Only if the home receiving device 10 has been authenticated to be able to receive the program data, the broadcast receiving unit 21 receives a notification of permission for receiving from the authentication unit 22 and descrambles the broadcast program data, and the program can be viewed at the video output device 20.

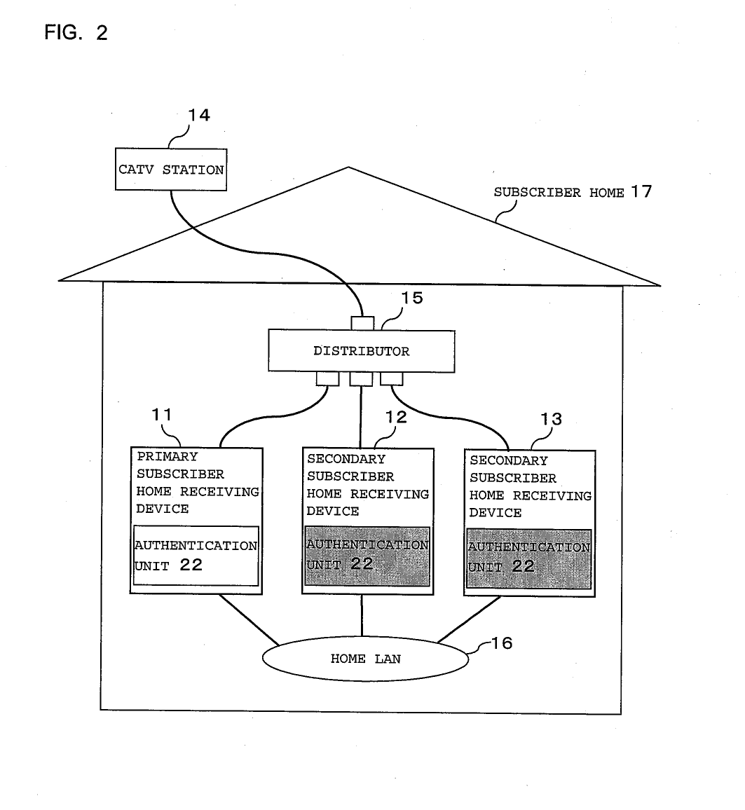

FIG. 2 shows a connection configuration diagram of a CATV system in a home subscribing for multiple home receiving devices of this first embodiment. FIG. 2 shows a subscriber home 17 having one primary subscriber home receiving device 11 and two secondary subscriber home receiving devices 12 and 13, that is, three devices in total.

All of the primary subscriber home receiving device 11 and the secondary subscriber home receiving devices 12 and 13 shown in FIG. 2 have the similar configuration as the home receiving device 10 shown in FIG. 1. It should be noted that the same reference numerals are used for the same component parts as FIG. 1.

The broadcast program data delivered from the CATV station 14 is distributed by a distributor 15, and the distributed broadcast program data is inputted to the primary subscriber home receiving device 11 and the secondary subscriber home receiving devices 12 and 13, respectively.

The primary subscriber home receiving device 11 and the secondary subscriber home receiving devices 12 and 13 are connected to one another via the home LAN 16, and this home LAN 16 is used to perform connection authentication with respect to another home receiving device.

It should be noted that all of the home receiving device 10, the primary subscriber home receiving device 11 and the secondary subscriber home receiving devices 12 and 13 correspond to an example of a video receiving device of the present invention. Moreover, the primary subscriber home receiving device 11 corresponds to an example of a master video receiving device of the present invention, and both of the secondary subscriber home receiving devices 12 and 13 correspond to an example of slave video receiving devices of the present invention.

Moreover, the broadcast program data delivered from the CATV station 14 corresponds to an example of external video data of the present invention, and the configuration of the CATV system shown in FIG. 2 corresponds to an example of a video data receiving system of the present invention. Moreover, the broadcast receiving unit 21 corresponds to an example of a video data receiving unit of the present invention, and the home LAN 16 corresponds to an example of a network for the authentication of the present invention.

Although all of the home receiving devices 11 to 13 are provided with the authentication unit 22 having the authentication function, the authentication privilege management unit 24 in each of the home receiving devices 11 to 13 manages the authentication function so that the authentication function of the authentication unit 22 in only one of multiple home receiving devices 11 to 13 for which one home has subscribed is enabled. In the authentication unit 22 in each of the home receiving devices other than the home receiving device having the enabled authentication function, only the authentication receiving function is enabled.

The home receiving device having the enabled authentication function is herein referred to as “having a representation right”. In other words, in this first embodiment, only one of the home receiving devices 11 to 13 is controlled to have the representation right at a certain point. Depending on a communication method, the representation right may include a master function for performing sending opportunity assignment of TDMA communication and the like.

In the CATV system of this first embodiment, if the power of the primary subscriber home receiving device 11 is on, the primary subscriber home receiving device 11 is controlled to have this representation right. Among the authentication units 22 in the respective home receiving devices 11 to 13 of FIG. 2, the authentication unit 22 with a bright color background shows that it has the representation right, and the authentication unit 22 with a dark color background shows that it has no representation right. FIG. 2 shows a state where the power of all of the home receiving devices 11 to 13 is turned on and links thereof have been established via the home LAN 16, and the authentication unit 22 in the primary subscriber home receiving device 11 has the representation right.

In the home receiving device which has no representation right and has not been authenticated, television viewing is limited and the television viewing cannot be performed. The secondary subscriber home receiving devices 12 and 13 typically have no representation right and the television viewing cannot be performed by itself. In the case of FIG. 2, if the link with the primary subscriber home receiving device 11 has been established via the home LAN 16, and the secondary subscriber home receiving devices 12 and 13 are authenticated, the television viewing is permitted.

Next, a method of controlling the authentication among the home receiving devices in the CATV system of this first embodiment will be described by using FIGS. 1 to 4.

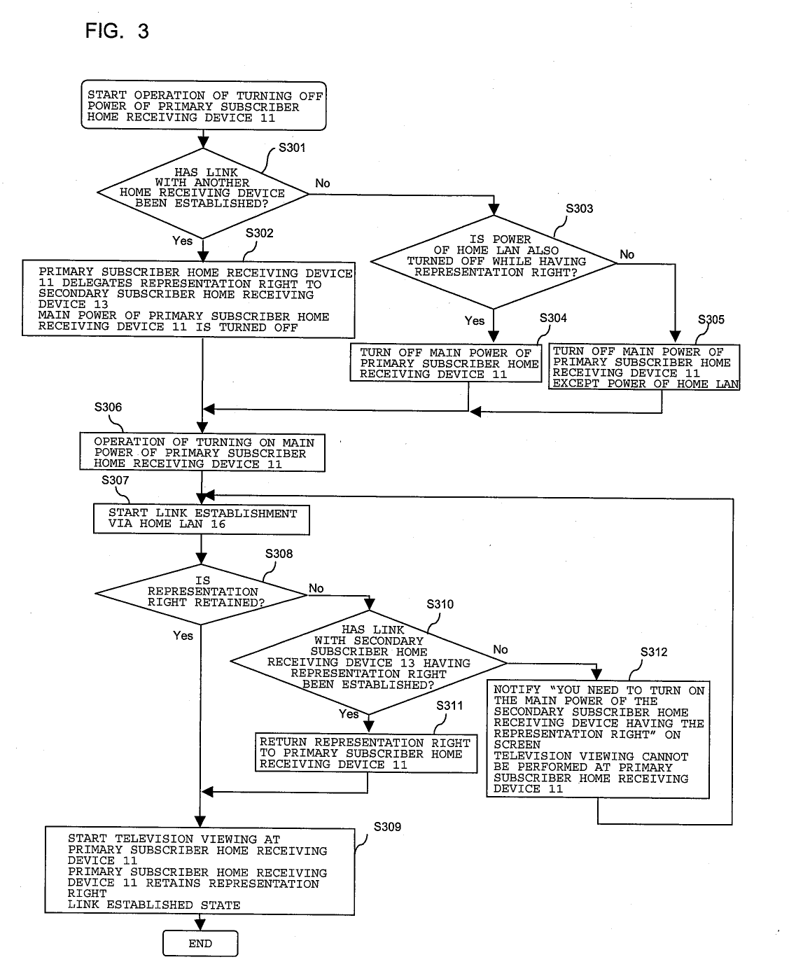

FIG. 3 shows a flowchart showing operations of the primary subscriber home receiving device 11 in the case where main power of the primary subscriber home receiving device 11 has been turned off and subsequently turned on again, in the subscriber home 17 of FIG. 2.

If an operation of turning off the power SW 25 of the primary subscriber home receiving device 11 is performed, the power control unit 26 senses it, and the authentication privilege management unit 24 determines whether or not the link with other secondary subscriber home receiving devices 12 and 13 has been established (S301). At this point, if the link has been established, the representation right is delegated to any of the other secondary subscriber home receiving devices 12 and 13, and the main power of the primary subscriber home receiving device 11 is turned off (S302). Here, it is assumed that the representation right has been delegated to the secondary subscriber home receiving device 13. At this point, the primary subscriber home receiving device 11 may store which secondary subscriber home receiving device the representation right has been delegated to, as an operation history. In the case of this embodiment, it is assumed that the primary subscriber home receiving device 11 has stored the delegation of the representation right to the secondary subscriber home receiving device 13.

If there is no other home receiving device with which the link has been established at step S301, a user is asked whether or not to also turn off the power of the network I/F unit 23 connected to the home LAN 16 while having the representation right (S303). At this point, the user can select whether to turn off the main power including the power of the network I/F unit 23 (S304) or to turn off only the main power while the power of the network I/F unit 23 and the like which perform the authentication control is turned on (S305).

It should be noted that asking the user at step S303 corresponds to an example of a warning notification of the present invention.

Here, it is assumed that if the power of the authentication unit 22, the authentication privilege management unit 24 and the network I/F unit 23 which perform the authentication control is on, the link with other secondary subscriber home receiving devices 12 and 13 can be established and also the authentication can be performed. Therefore, in the case where even the main power of the primary subscriber home receiving device 11 is turned off while the power of the network I/F unit 23 and the like which perform the authentication control is on (S305), even if the power of the secondary subscriber home receiving device 12 or 13 is previously turned on when the power of all other home receiving devices 12 and 13 is off, the secondary subscriber home receiving device 12 or 13 can be connected to the primary subscriber home receiving device 11 via the home LAN 16, and the authentication and the television viewing can be performed.

It should be noted that whether or not to turn off the power of the network I/F unit 23 and the like which perform the authentication control may not be selected by the user, but may be set by default.

Next, if an operation of turning on the power SW 25 of the primary subscriber home receiving device 11 whose main power has been turned off is performed (S306), the power control unit 26 senses it, and the network I/F unit 23 starts the link establishment via the home LAN 16 (S307).

At this point, the authentication privilege management unit 24 determines whether or not the primary subscriber home receiving device 11 retains the representation right (S308). If the primary subscriber home receiving device 11 retains the representation right, the television viewing at the primary subscriber home receiving device 11 is started, and also the authentication of other secondary subscriber home receiving devices 12 and 13 is performed by the authentication unit 22 (S309).

If the primary subscriber home receiving device 11 retains no representation right at step S308, the authentication privilege management unit 24 determines whether or not the link with the secondary subscriber home receiving device 13 having the representation right has been established (S310). Then, if the link has been established, the representation right is controlled to be returned to the primary subscriber home receiving device 11 (S311). If the link with the secondary subscriber home receiving device 13 having the representation right is not established, the user is notified of “you need to turn on the main power of the secondary subscriber home receiving device having the representation right” on a screen, and the television viewing cannot be performed at the primary subscriber home receiving device 11 at this time (S312). At this point, in contents of the screen notification, the home receiving device having the representation right may have been identified as “the secondary subscriber home receiving device 13”, by using the operation history stored at S301 and S302.

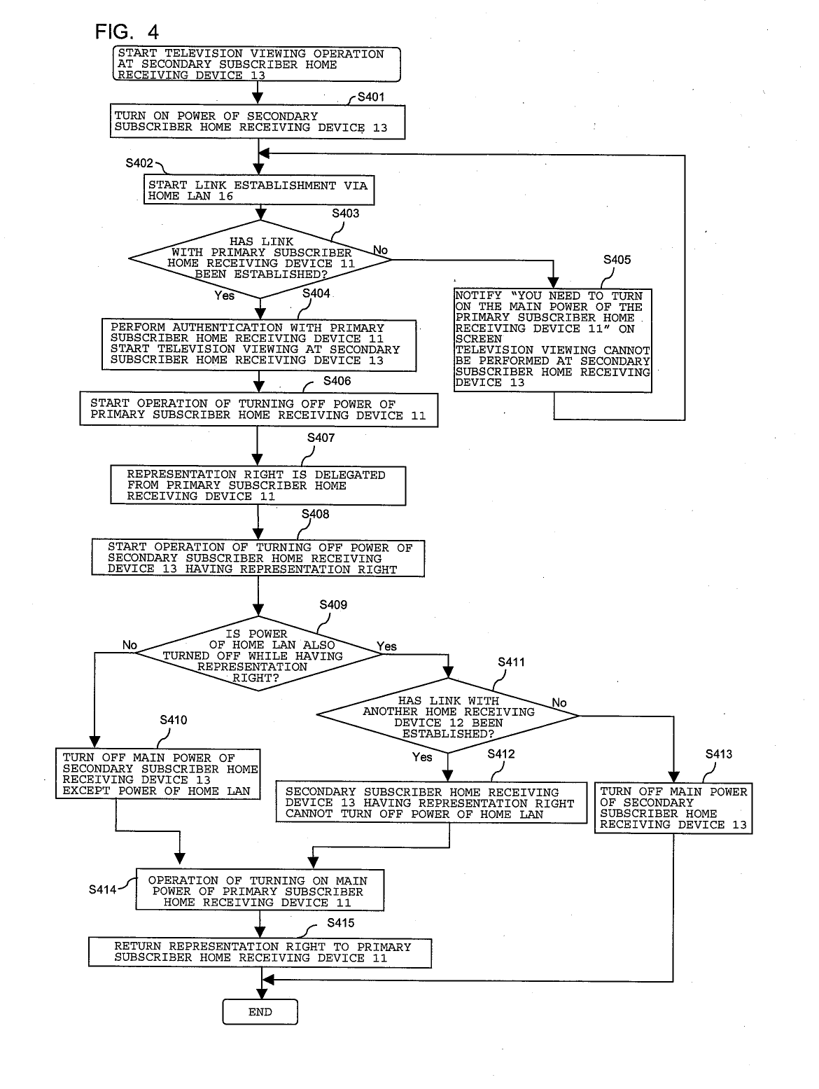

FIG. 4 shows a flowchart showing operations of the secondary subscriber home receiving device 13 to which the representation right is delegated in the case where the main power of the primary subscriber home receiving device 11 has been turned off in the subscriber home 17 of FIG. 2.

First, if the power SW 25 of the secondary subscriber home receiving device 13 is turned on (S401), the power control unit 26 senses it, and the network I/F unit 23 starts the link establishment via the home LAN 16 (S402). Then the authentication privilege management unit 24 determines the link establishment with the primary subscriber home receiving device 11 (S403).

If the link with the primary subscriber home receiving device 11 has been established, the authentication is performed, and if the authentication unit 22 is authenticated by the authentication unit 22 in the primary subscriber home receiving device 11, the television viewing at the secondary subscriber home receiving device 13 can be started (S404). Here, if the link with the primary subscriber home receiving device 11 has not been established, the user is notified of “you need to turn on the main power of the primary subscriber home receiving device 11” on the screen, and the television viewing cannot be performed at the secondary subscriber home receiving device 13 at this time (S405).

Then, if the operation of turning off the power SW 25 of the primary subscriber home receiving device 11 is performed (S406), the power control unit 26 senses it, and the representation right delegation control is performed between the authentication privilege management units 24 in the primary subscriber home receiving device 11 and the secondary subscriber home receiving device 13. After the representation right has been delegated from the primary subscriber home receiving device 11 to the secondary subscriber home receiving device 13 (S407), the power of the primary subscriber home receiving device 11 is turned off.

Subsequently, since the secondary subscriber home receiving device 13 having the delegated representation right establishes the link with the secondary subscriber home receiving device 12 via the home LAN 16, and the authentication unit 22 in the secondary subscriber home receiving device 13 performs the authentication, both of the secondary subscriber home receiving device 12 and the secondary subscriber home receiving device 13 can perform the television viewing even if the main power of the primary subscriber home receiving device 11 is off.

Next, if an operation of turning off the power SW 25 of the secondary subscriber home receiving device 13 having the representation right is performed (S408), the power control unit 26 senses it, and the user is asked whether or not to turn off the main power including the power of the network I/F unit 23 connected to the home LAN 16 while the power control unit 26 has the representation right (S409).

Here, if the user selects “not turn off the power of the network I/F unit 23”, only the main power is turned off while the power of the network I/F unit 23 and the like which perform the authentication control is turned on (S410).

Here, if the user selects “also turn off the power of the network I/F unit 23”, the authentication privilege management unit 24 determines whether or not the link with another home receiving device has been established (S411). In the case of this example, it is determined whether or not the link with the secondary subscriber home receiving device 12 has been established. If the link with another home receiving device has been established, the secondary subscriber home receiving device 13 having the representation right cannot turn off the power of the network I/F unit 23 (S412). Therefore, in that case, the control is performed so that only the main power is turned off while the power of the network I/F unit 23 and the like which perform the authentication control is turned on, and the like, for example.

On the other hand, as a result of the determination, if the link with another home receiving device has not been established, the main power is turned off including the power of the network I/F unit 23 while retaining the representation right (S413). Here, whether or not to turn off the power of the network I/F unit 23 may not be selected by the user, but may be set by default.

However, if the main power is turned off including the power of the network I/F unit 23 and the like (S413), when the power of another home receiving device is turned on while the power of the secondary subscriber home receiving device 13 retaining the representation right is turned off, the television viewing cannot be performed. Therefore, if the power of the primary subscriber home receiving device 11 is turned on, the user is notified of “you need to turn on the main power of the secondary subscriber home receiving device having the representation right” on the screen, and if the power of the secondary subscriber home receiving device 12 is turned on, the user is notified of “you need to turn on the main power of the primary subscriber home receiving device 11” on the screen, since it is unknown which home receiving device retains the representation right.

In a state where the secondary subscriber home receiving device 13 retains the representation right, when the main power is off but the power of the network I/F unit 23 and the like which perform the authentication control is on (S410 and S412), if the operation of turning on the power SW 25 of the primary subscriber home receiving device 11 is performed (S414), the representation right is returned to the primary subscriber home receiving device 11 (S415) when the link with the secondary subscriber home receiving device 13 having the representation right has been established.

Since the representation right delegation control is performed as described above, even if the power of the primary subscriber home receiving device 11 is turned off, the secondary subscriber home receiving device 12 or 13, which is legitimate, can perform the television viewing by itself.

In this way, in the CATV system of this first embodiment, the primary subscriber home receiving device 11 normally has the representation right, and after the representation right has been delegated from the primary subscriber home receiving device 11 to the secondary subscriber home receiving device 13, when the power of the primary subscriber home receiving device 11 is turned on and connected to the secondary subscriber home receiving device 13 having the representation right via the home LAN 16, the representation right is returned to the primary subscriber home receiving device 11.

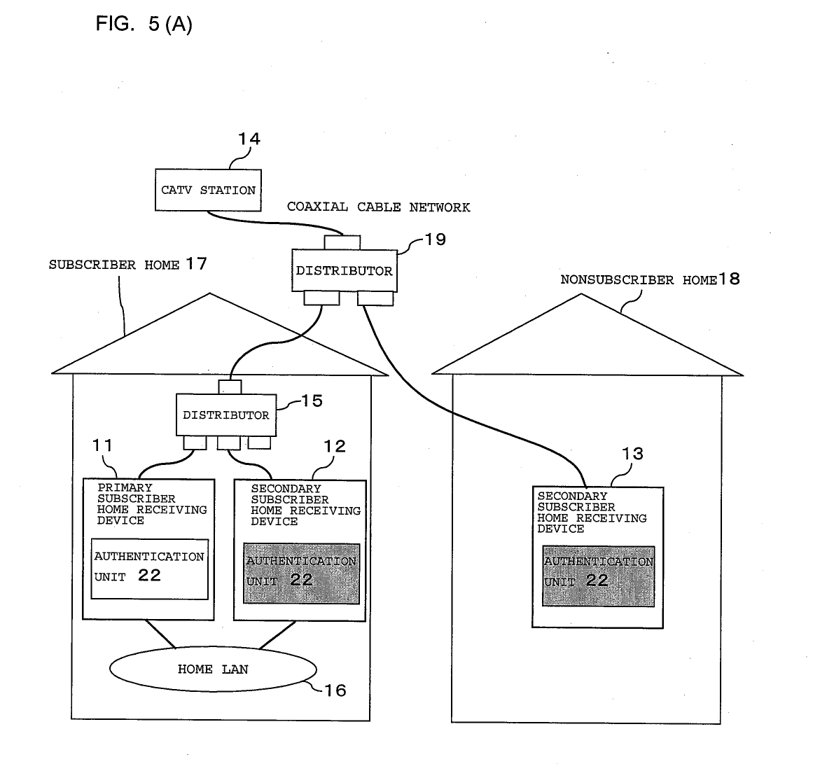

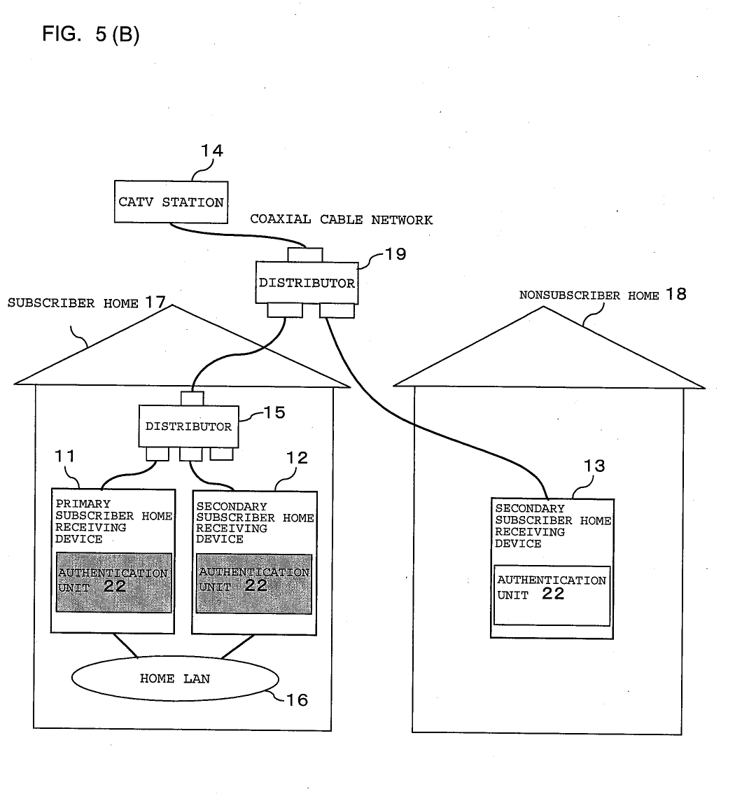

FIGS. 5(A) and (B) show configuration diagrams of connection examples in the case where unauthorized television viewing is attempted in the CATV system of this first embodiment shown in FIG. 2. FIG. 5(A) shows an example in which the secondary subscriber home receiving device 13 not having the representation right has been brought into a nonsubscriber home 18, and FIG. 5(B) shows an example in which the secondary subscriber home receiving device 13 having the representation right has been brought into the nonsubscriber home 18, respectively.

In the case of FIG. 5(A), even if the secondary subscriber home receiving device 13 for which the subscriber home 17 has subscribed is brought into the nonsubscriber home 18, and the television viewing is attempted by receiving the broadcast program data distributed by a distributor 19, since the secondary subscriber home receiving device 13 has no representation right, cannot establish the link with the primary subscriber home receiving device 11 having the representation right and is not authenticated, the television viewing will be limited.

Moreover, in the case of FIG. 5(B), if the secondary subscriber home receiving device 13 for which the subscriber home 17 has subscribed is brought into the nonsubscriber home 18, since the representation right has been still delegated to the secondary subscriber home receiving device 13, the television viewing is enabled at the nonsubscriber home 18. However, in this case, since the primary subscriber home receiving device 11 and the secondary subscriber home receiving device 12 in the subscriber home 17 cannot establish the link with the secondary subscriber home receiving device 13 having the representation right via the home LAN 16 and are not authenticated, the television viewing at these home receiving devices 11 and 12 will be limited.

Therefore, unlimited television viewing cannot be performed simultaneously at both of the subscriber home 17 and the nonsubscriber home 18 only with subscription fee of the subscriber home 17, which can prevent unauthorized use of performing the television viewing with unreasonably inexpensive fee.

Moreover, the same applies to the case where the primary subscriber home receiving device 11 has been brought into the nonsubscriber home 18. If the primary subscriber home receiving device 11 still retaining the representation right has been brought into the nonsubscriber home 18, the television viewing at the secondary subscriber home receiving devices 12 and 13 in the subscriber home 17 will be limited, and if the primary subscriber home receiving device 11 which has delegated the representation right has been brought into the nonsubscriber home 18, the television viewing at the nonsubscriber home 18 will be limited.

In this way, when the home receiving devices of the CATV system of this first embodiment are used, unreasonable use of performing the television viewing with the unreasonably inexpensive fee can be certainly prevented, and also, even if the power of the primary subscriber home receiving device 11 having the representation right is turned off, other secondary subscriber home receiving devices 12 and 13 can perform the television viewing by themselves.

### Second Embodiment

Next, an authentication control method among the home receiving devices in the CATV system of a second embodiment of the present invention will be described.

The CATV system of this second embodiment has the authentication control method among the home receiving devices, which is different from the first embodiment, and has a system configuration similar to that of the first embodiment, as shown in FIGS. 1 and 2.

In the first embodiment, the delegation of the representation right has been performed only between the primary subscriber home receiving device and the secondary subscriber home receiving device. However, in this second embodiment, the delegation of the representation right is also performed from the secondary subscriber home receiving device to which the representation right has been delegated, to another secondary subscriber home receiving device.

Since the representation right delegation method between the primary subscriber home receiving device and the secondary subscriber home receiving device is similar to the first embodiment, only the representation right delegation method from the secondary subscriber home receiving device to which the representation right has been delegated, to another secondary subscriber home receiving device, which is different from the first embodiment, will be described below.

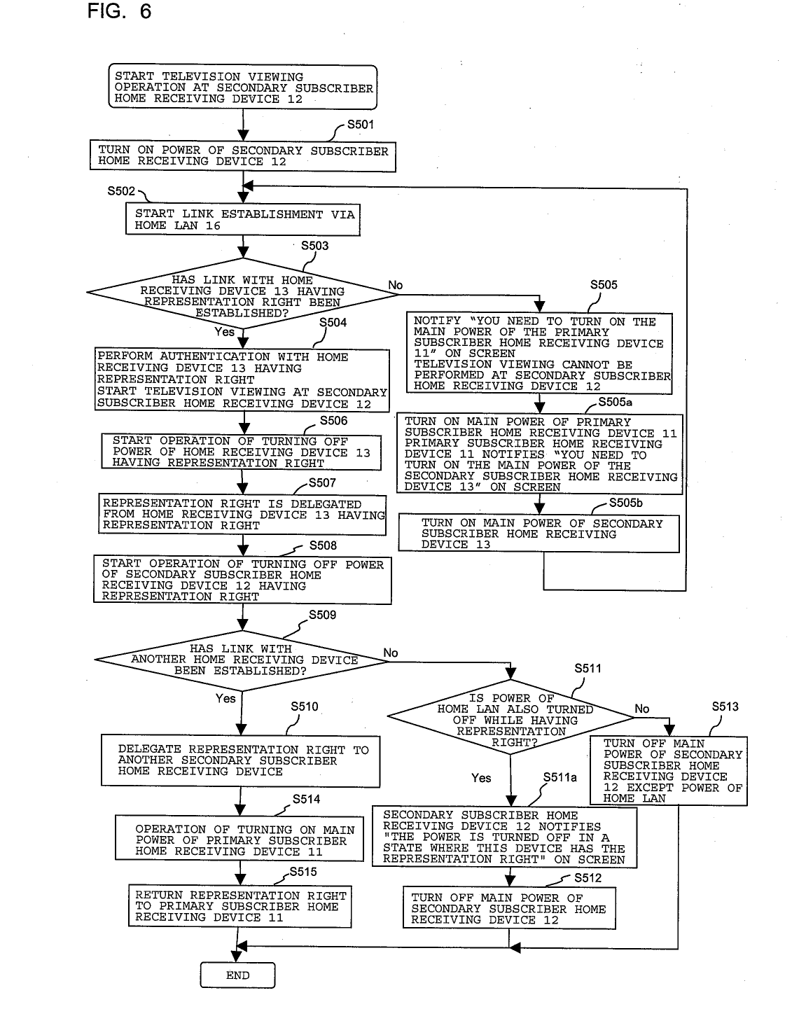

FIG. 6 shows a flowchart showing operations of the respective secondary subscriber home receiving devices in the case where the main power of the secondary subscriber home receiving device retaining the representation right has been turned off, in the subscriber home 17 of FIG. 2.

Here, this embodiment will be described by using FIGS. 1, 2 and 6, assuming that the power of the primary subscriber home receiving device 11 has been turned off and the secondary subscriber home receiving device 13 retains the representation right. The representation right delegation operation from the primary subscriber home receiving device 11 to the secondary subscriber home receiving device 13 is similar to the delegation operation of the first embodiment described in FIG. 3.

If the power SW 25 of the secondary subscriber home receiving device 12 is turned on (S501), the power control unit 26 senses it, and the network I/F unit 23 starts the link establishment via the home LAN 16 (S502). Then the authentication privilege management unit 24 determines the link establishment with the home receiving device having the representation right (S503).

If the link with the home receiving device having the representation right (the secondary subscriber home receiving device 13, in this example) has been established, the authentication is performed, and if the authentication unit 22 is authenticated by the authentication unit 22 in the secondary subscriber home receiving device 13, the television viewing at the secondary subscriber home receiving device 12 can be started (S504).

On the other hand, unless the link with the secondary subscriber home receiving device 13 having the representation right has been established, the television viewing at the secondary subscriber home receiving device 12 cannot be performed. Here, as a state where the link has not been established, for example, the case where the power of the secondary subscriber home receiving device 13 has been also turned off can be cited.

At this point, the secondary subscriber home receiving device 12 notifies the user of “you need to turn on the main power of the primary subscriber home receiving device 11” on the screen (S505). Here, the reason why the contents of the screen notification are directed to the primary subscriber home receiving device 11 is as follows. In other words, it is based on the fact that the secondary subscriber home receiving device 12 has not been notified of that the representation right has been delegated from the primary subscriber home receiving device 11 to the secondary subscriber home receiving device 13, and the fact that the primary subscriber home receiving device 11 has been previously defined as the device having the representation right in the respective secondary subscriber home receiving devices, that is, the secondary subscriber home receiving devices 12 and 13, at the time of implementing the device, the time of the subscription to a CATV company, or the like.

The user checks the above described screen notification, and according to the contents thereof, turns on the power of the primary subscriber home receiving device 11. Here, the primary subscriber home receiving device 11 has previously stored which home receiving device is the secondary subscriber home receiving device to which the representation right has been delegated, and the user is notified of “you need to turn on the main power of (the home receiving device to which the representation right has been delegated)” on the screen. It should be noted that a name, a device number or the like with which the home receiving device can be identified is displayed at a part of (the home receiving device to which the representation right has been delegated) notified on the screen. In this case, since the primary subscriber home receiving device 11 has delegated the representation right to the secondary subscriber home receiving device 13, the user is notified of “you need to turn on the main power of the secondary subscriber home receiving device 13” on the screen (S505a).

The user checks the above described screen notification, and according to the contents thereof, turns on the power of the secondary subscriber home receiving device 13 (S505b). The link establishment between the secondary subscriber home receiving device 12 and the secondary subscriber home receiving device 13 is started via the home LAN 16 by turning on the power of the secondary subscriber home receiving device 13 (S502). It should be noted that the power of the primary subscriber home receiving device 11 which is not currently used for the authentication has preferably been turned off again.

It should be noted that, although the link has been established by the secondary subscriber home receiving device 13 having the representation right in the above description, if other secondary subscriber home receiving devices have been connected onto the home LAN 16, and the home receiving device to which the representation right has been delegated, which has been notified on the screen (the secondary subscriber home receiving device 13, in this case), also currently retains no representation right because it has delegated the representation right to any one of the other home receiving devices, it has been set so that the user is notified of “you need to turn on the main power of (the home receiving device to which the representation right has been delegated)” on the screen also when the power of the above described home receiving device is turned on.

In other words, the home receiving device which has delegated the representation right to another home receiving device stores the operation of the above described delegation as the operation history, and information related to the home receiving device to which the representation right has been delegated has been set to be notified on the screen if the link is not established. According to the above described setting, if the power of the home receiving devices which have been notified on the screen is turned on in order, when the power of the home receiving device retaining the representation right is turned on, the link will be established and the authentication will be performed.

By processing as described above, without blindly turning on the power of all other home receiving devices, the authentication is performed at the time of turning on the power of the home receiving device retaining the representation right, and the television viewing is enabled. It should be noted that, in the above described series of operations, the screen notification of turning on the main power of the home receiving device is an example of the notification of information related to the video receiving device to which the above described authentication privilege has been delegated, of the present invention.

Then, after the television viewing has been started at the secondary subscriber home receiving device 12 (S504), when the operation of turning off the power SW 25 of the secondary subscriber home receiving device 13 having the representation right is performed (S506), the representation right delegation control is performed between the authentication privilege management units 24 in the secondary subscriber home receiving devices 12 and 13. After the representation right has been delegated from the secondary subscriber home receiving device 13 which has retained the representation right to the secondary subscriber home receiving device 12 (S507), the power of the secondary subscriber home receiving device 13 is turned off. At this point, similarly to the cases of S505, S505a and S505b, the secondary subscriber home receiving device 13 stores the representation right delegation to the secondary subscriber home receiving device 12, as the operation history.

Furthermore, if an operation of turning off the power of the secondary subscriber home receiving device 12 to which the representation right has been delegated is started (S508), the authentication privilege management unit 24 in the secondary subscriber home receiving device 12 determines whether or not the link with another home receiving device, except the primary subscriber home receiving device 11 and the secondary subscriber home receiving device 13 whose power is currently turned off, has been established (S509). At this point, if there is another secondary subscriber home receiving device with which the link has been further established, after the representation right has been delegated to the above described secondary subscriber home receiving device (S510), the power of the secondary subscriber home receiving device 12 is turned off. Also at this time, similarly to the operation of turning off the power of the secondary subscriber home receiving device 13, the secondary subscriber home receiving device 12 stores the representation right delegation to the above described another secondary subscriber home receiving device, as the operation history.

The home device to which the representation right has been delegated once and which has redelegated the representation right, notifies the user of “you need to turn on the main power of (the home receiving device to which the representation right has been delegated)” on the screen based on the operation history stored therein, when the power is turned on. Therefore, when the user turns on the power of the home receiving devices which have been notified on the screen in order, and turns on the power of the home receiving device retaining the representation right, the link is established and the authentication is performed.

Subsequently, in a state where any secondary subscriber home receiving device retains the representation right, if the operation of turning on the power SW 25 of the primary subscriber home receiving device 11 is performed (S514), the network I/F unit 23 starts the link establishment via the home LAN 16, and the representation right is returned to the primary subscriber home receiving device 11 (S515) when the link with the secondary subscriber home receiving device having the representation right is established.

On the other hand, at step S509, like this example, if the power of all home receiving devices other than the secondary subscriber home receiving device 12 has been turned off and the link has not been established, the user is asked whether or not to also turn off the power of the network I/F unit 23 connected to the home LAN 16 while having the representation right (S511). Here, the user can select whether to turn off the main power including the power of the network I/F unit 23 (S512) or to turn off only the main power while the power of the network I/F unit 23 and the like which perform the authentication control is turned on (S513). It should be noted that whether or not to turn off the power of the network I/F unit 23 and the like which perform the authentication control may not be selected by the user, but may be set by default.

In the secondary subscriber home receiving device 12 to which the representation right has been delegated, in the case where the power of the network I/F unit 23 and the like which perform the authentication control is turned on while other main power is turned off (S513), even if the power of the home receiving device not having the representation right is previously turned on when the power of all other home receiving devices is off, it can be connected with the secondary subscriber home receiving device 12 having the representation right via the home LAN 16, and the authentication and the television viewing can be performed.

On the other hand, in the case where the main power is turned off including the power of the network I/F unit 23 and the like (S512), even if the power of another home receiving device is turned on while the power of the secondary subscriber home receiving device 12 retaining the representation right is turned off, the television viewing cannot be performed. Similarly to the cases of S505, S505a and S505b, when the power of the secondary subscriber home receiving device 13 which has delegated the representation right is turned on again, the secondary subscriber home receiving device 13 notifies the user of “you need to turn on the main power of the secondary subscriber home receiving device 12 (to which the representation right has been delegated)” on the screen, with respect to the home receiving device 12 to which the representation right has been delegated.

Moreover, also on the side of the secondary subscriber home receiving device 12, before the main power is turned off (S512), the user is notified of “the power is turned off in a state where this device has the representation right” on the screen (S511a). In this case, the user can check which home receiving device (the secondary subscriber home receiving device 12, in this example) has to be used to perform the authentication, before launching another home receiving device. Here, it should be noted that the notification at S511a is an example of the warning notification of the present invention. Moreover, this notification may be performed prior to the operation at S304 of FIG. 3, or prior to S413 of FIG. 4, of the first embodiment.

It should be noted that, in the above described example, at steps S514 and S515, if the operation of turning on the power SW 25 of the primary subscriber home receiving device 11 has been performed, the representation right has been returned to the primary subscriber home receiving device 11, however, even if the operation of turning on the power SW 25 of the primary subscriber home receiving device 11 has been performed, the representation right may not be returned to the primary subscriber home receiving device 11 and the secondary subscriber home receiving device retaining the representation right at that point may continue retaining the representation right. In other words, the home receiving device retaining the representation right may retain the representation right until the power of that home receiving device itself is turned off.

In the case of the first embodiment, when there are multiple secondary subscriber home receiving devices, in order to enable the television viewing in a state where the power of only one secondary subscriber home receiving device is turned on, it has been necessary to have a function of previously turning on the power of only the network I/F unit 23 and the like which perform the authentication control. For example, in the case of the configuration shown in FIG. 2, if the power is turned off in order of the primary subscriber home receiving device 11 and the secondary subscriber home receiving device 12, the television viewing could not be performed in a state where the power of only the secondary subscriber home receiving device 13 is turned on, without having this function.

In the case of this second embodiment, since the representation right delegation between the secondary subscriber home receiving devices has been permitted, even without having the function of previously turning on the power of only the network I/F unit 23 and the like which perform the authentication control, the television viewing can be performed at only one secondary subscriber home receiving device by itself even if the power of other home receiving devices is turned off.

It should be noted that the user may previously set whether or not to permit the representation right delegation between the secondary subscriber home receiving devices.

Moreover, although the respective embodiments have been described with the configuration having two secondary subscriber home receiving devices, the configuration may have three or more secondary subscriber home receiving devices, which can provide similar advantages.

Moreover, although the respective embodiments have been described assuming that the home receiving device to which the representation right is delegated from the primary subscriber home receiving device 11 is the secondary subscriber home receiving device 13, the representation right may be delegated to any other secondary subscriber home receiving device connected to home LAN 16. For example, the home receiving device to which the representation right is delegated may be randomly selected and the representation right may be delegated to the above described home receiving device. Alternatively, the user may select the home receiving device to which the representation right is delegated, in each case. Moreover, the home receiving device to which the representation right is delegated may be determined based on statistical information and the like.

For example, as an example of the statistical information, the home receiving device to which the representation right is delegated may be determined as a home receiving device having the longest accumulated power-on time. In this way, the representation right may be retained by a home receiving device having a long viewing time, that is, a frequently used home receiving device, with a high probability, and a probability of turning on the power of the home receiving device having the representation right when the power SW is newly turned on can be increased.

Moreover, in such a case where the home receiving device to which the representation right is delegated is determined based on the statistical information, the home receiving device to which the representation right is delegated may be determined regardless of the primary subscriber or the secondary subscriber. For example, even if the link with the primary subscriber home receiving device has been established when the power of the secondary subscriber receiving device having the representation right is turned off, in such a case where the link has been established also with a secondary subscriber receiving device having an accumulated power-on time longer than the primary subscriber home receiving device, the representation right may not be delegated to the primary subscriber receiving device, but may be delegated to that secondary subscriber receiving device having the longer accumulated power-on time.

Moreover, although the above described respective embodiments have been described, as illustrated in FIG. 1, assuming that the home LAN 16 is realized by the Ethernet and the like for example and is a network physically independent of a coaxial cable network which transmits or distributes CATV video signals, the network of the present invention may be realized as a cable network using a CATV coaxial cable or other broadcast cables. In this case, it is not necessary to separately prepare a LAN cable and the like which connect the respective home receiving devices, which enables easier installation and setting of the devices.

Moreover, although the above described respective embodiments have been described assuming that all of the primary subscriber home receiving device 11 and the secondary subscriber home receiving devices 12 and 13, which are connected to the home LAN 16, are the home receiving device 10 shown in FIG. 1, having the common configuration, the primary subscriber home receiving device and the secondary subscriber home receiving devices may have different configurations.

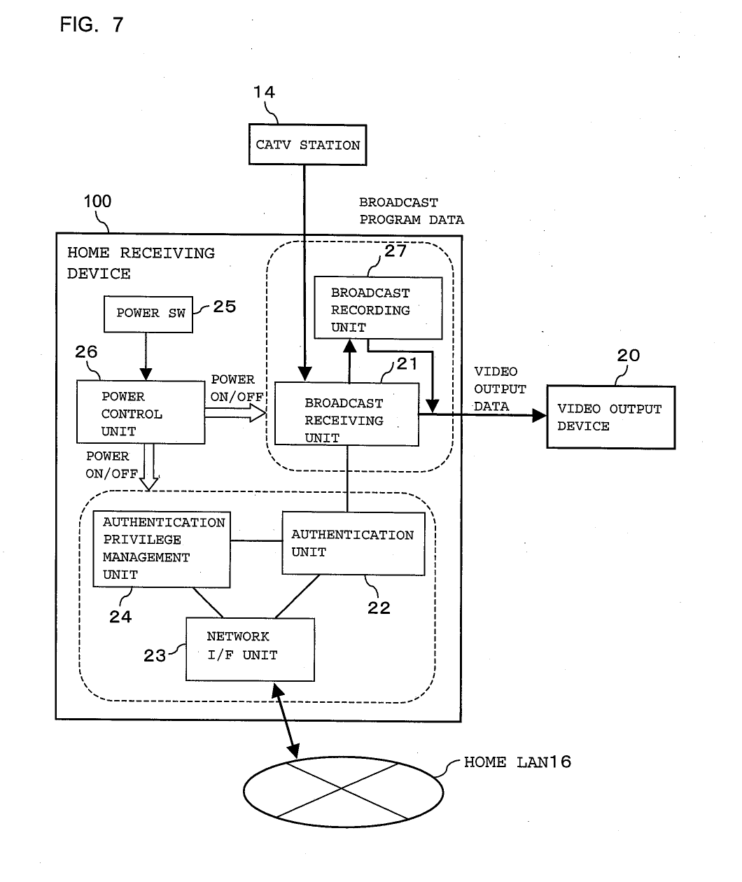

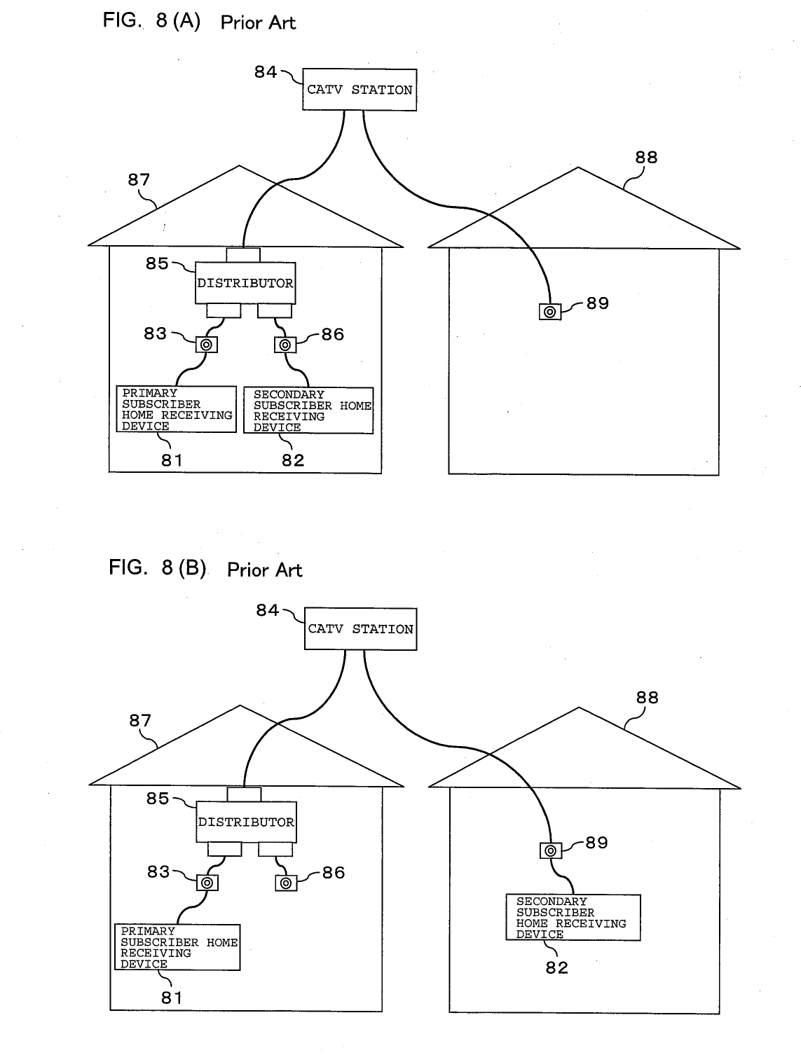

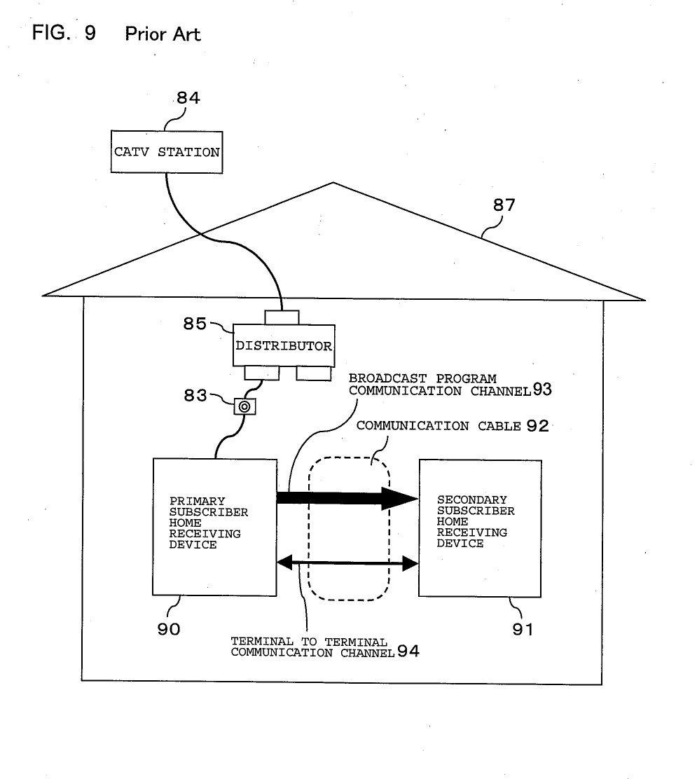

FIG. 7 is a block diagram showing a configuration example of a home receiving device 100 as the primary subscriber home device. However, the same reference numerals are attached to the same or corresponding parts as FIG. 1, and a detailed description thereof is omitted. The home receiving device 100 in this configuration example differs from the home receiving device 10 of FIG. 1 in that the home receiving device 100 is provided with a broadcast recording unit 27 which records video data received by the broadcast receiving unit 21. The broadcast recording unit 27 is a unit utilizing a high-capacity recording medium such as an HDD (hard disk drive), a BD (Blu-ray Disc) drive, a DVD-ROM drive or the like, and can play a recorded program to output at the video output device 20 or distribute the recorded program to another home receiving device 12 via the distributor 15 and enable the recorded program to be viewed.

In the CATV system including the home receiving device 100 as described above, since a similar authentication as the above described respective embodiments is required not only in the case of directly receiving from the CATV station 14, but also in the case of distributing the video data recorded in the broadcast recording unit 27 to another home receiving device, the authentication control method among the home receiving devices can be applied. Moreover, since importance of this device has been increased because it has the configuration capable of recording the program, the device has become more preferred as a primary subscriber target device to which the representation right should be constantly returned. It should be noted that the broadcast recording unit corresponds to an example of a recording unit of the present invention.

Moreover, a program of the present invention is a program which causes a computer to execute operations of the above described authentication step in which the above described authentication unit permits the above described other video receiving devices to receive the above described external video data, and/or the above described authentication privilege delegation step in which the above described authentication privilege management unit of the above described predetermined one of the video receiving devices delegates the above described authentication privilege to any of other video receiving devices which have been connected to the above described network and with which links have been established, of the above described authentication control method for the video data receiving system of the present invention, and is a program which operates in cooperation with the computer.

Moreover, a recording medium of the present invention is a recording medium having recorded a program which causes a computer to execute operations of the above described authentication step in which the above described authentication unit permits the above described other video receiving devices to receive the above described external video data, and/or the above described authentication privilege delegation step in which the above described authentication privilege management unit of the above described predetermined one of the video receiving devices delegates the above described authentication privilege to any of other video receiving devices which have been connected to the above described network and with which links have been established, of the above described authentication control method for the video data receiving system of the present invention, and is a recording medium readable by the computer in which the above described read program is used in cooperation with the above described computer.

Moreover, a form of usage of the program of the present invention may be an aspect of being recorded in a computer readable recording medium and of operating in cooperation with the computer.

Moreover, the recording medium includes a ROM and the like.

Moreover, the above described computer of the present invention is not limited to pure hardware such as a CPU, and may include firmware, an OS, and further a peripheral device.

As described above, it should be noted that the configuration of the present invention may be realized in software or may be realized in hardware.

As described above, by using the home receiving device of the present invention, it is possible to enable the television viewing only at the legitimate secondary subscriber home receiving device, while preventing the unauthorized television viewing at another home, turning off the power of the primary subscriber home receiving device in the subscriber home, and intending to save electric power of the device and to extend operating life of the device.

The video receiving device, the video data receiving system, the authentication control method thereof and the like of the present invention are useful as a technique of preventing unauthorized use of the multiple devices for which the subscription to the company has been performed.

The video receiving device, the video data receiving system, the authentication control method thereof and the like according to the present invention has an advantage in which the television viewing can be performed at the video receiving device which receives the authentication, even if the power of the video receiving device which performs the authentication is turned off. Therefore, they are useful as multiple video receiving devices for which the subscription to the company such as the CATV station has been performed, the video data receiving system, the authentication control method thereof and the like.

What is claimed is:

1. A video data receiving system in which multiple video receiving devices are connected to one another via a network for authentication, each of said multiple video receiving devices comprising:
a power control unit which senses an instruction of turning off power and an instruction of turning on the power;
a video data receiving unit which receives at least external video data;
a network interface unit which connects to said network for the authentication;
an authentication unit which has an authentication function; and
an authentication privilege management unit which manages an authentication privilege for enabling said authentication function of said authentication unit,
wherein said authentication unit can permit other video receiving devices to receive said external video data, by said authentication function, and
when the power of a predetermined one of the video receiving devices having said authentication privilege is turned off, the power of said predetermined video receiving device is turned off after said authentication privilege management unit of said predetermined one of the video receiving devices has delegated said authentication privilege to any of other video receiving devices which have been connected to said network and with which links have been established.

2. The video data receiving system according to claim 1, wherein said multiple video receiving devices are one master video receiving device and one or a plurality of slave video receiving devices which are other than said master video receiving device, and
if the power is turned on in a state where said master video receiving device does not have said authentication privilege, when a link with said slave video receiving device having said authentication privilege has been established in said network, said authentication privilege is delegated from said slave video receiving device to said master video receiving device.

3. The video data receiving system according to claim 2, wherein said master video receiving device is provided with a recording unit which records said video data received by said video data receiving unit.

4. The video data receiving system according to claim 1, wherein the video receiving device having said authentication privilege retains said authentication privilege until the power of that video receiving device is turned off.

5. The video data receiving system according to claim 1, wherein when the power of the video receiving device having said authentication privilege is turned off, said authentication privilege management unit of that video receiving device has previously stored which video receiving device is the video receiving device to which said authentication privilege has been delegated among other video receiving devices.

6. The video data receiving system according to claim 5, wherein when the power of the video receiving device having said authentication privilege is turned on again, said authentication privilege management unit of that video receiving device notifies information related to the video receiving device to which said authentication privilege has been delegated.

7. The video data receiving system according to claim 1, wherein when the power of the video receiving device having said authentication privilege is turned off, a warning is notified if there is no other video receiving device with which the link has been established in said network.

8. The video data receiving system according to claim 1, wherein said power control unit has a function capable of turning off the power for operating other functions while the power for operating at least said network interface unit, said authentication unit and said authentication privilege management unit is turned on, and
when the power of the video receiving device having said authentication privilege is turned off, if there is no other video receiving device with which the link has been established in said network, the power for operating other functions is turned off while the power for operating said network interface unit, said authentication unit and said authentication privilege management unit is turned on.

9. The video data receiving system according to claim 1, wherein said other video receiving device to which said authentication privilege management unit of said predetermined one of the video receiving devices delegates said authentication privilege is determined based on statistical information related to frequency of usage of each of said multiple video receiving devices.

10. The video data receiving system according to claim 1, wherein said external video data is broadcast program data from a cable television station, and
each of said video receiving devices is an STB for a cable television.

11. The video data receiving system according to claim 10, wherein said network is a cable network which uses a cable used for transmitting said broadcast program data.

12. A video receiving device comprising:
a power control unit which senses an instruction of turning off power and an instruction of turning on the power;
a video data receiving unit which receives at least external video data;
a network interface unit which connects to a network for authentication;
an authentication unit which has an authentication function; and
an authentication privilege management unit which manages an authentication privilege for enabling said authentication function of said authentication unit,
wherein said authentication unit permits other video receiving devices to receive said external video data, by said authentication function, and
when the power is turned off in a state of having said authentication privilege, the power is turned off after said authentication privilege management unit has delegated said authentication privilege to any of other video receiving devices which have been connected to said network and with which links have been established.

13. An authentication control method for a video data receiving system in which multiple video receiving devices are connected to one another via a network for authentication, each of said multiple video receiving devices having a power control unit which senses an instruction of turning off power and an instruction of turning on the power; a video data receiving unit which receives at least external video data; a network interface unit which connects to said network for the authentication; an authentication unit which has an authentication function; and an authentication privilege management unit which manages an authentication privilege for enabling said authentication function of said authentication unit, said method comprising:
an authentication step in which said authentication unit permits other video receiving devices to receive said external video data, by said authentication function, and
an authentication privilege delegation step in which when the power of a predetermined one of the video receiving devices having said authentication privilege is turned off, said authentication privilege management unit of said predetermined one of the video receiving devices delegates said authentication privilege to any of other video receiving devices which have been connected to said network and with which links have been established, before the power is turned off.

14. A recording medium which can be used in a computer, having recorded a program which causes a computer to execute said authentication step in which said authentication unit permits said other video receiving devices to receive said external video data, and said authentication privilege delegation step in which said authentication privilege management unit of said predetermined one of the video receiving devices delegates said authentication privilege to any of other video receiving devices which have been connected to said network and with which the links have been established, of an authentication control method for a video data receiving system according to claim 13.
